(19) United States
(12) Patent Application Publication
(10) Pub. No.: US 2026/0367616 A1
(43) Pub. Date: Nov. 19, 2026

(54) Internet of Things-Driven Incident Simulation and Visualization

(71) Applicant: International Business Machines Corporation, Armonk, NY (US)

(72) Inventors: Namit Kabra, Hyderabad (IN); Sarbajit Kumar Rakshit, Kolkata (IN)

(21) Appl. No.: 19/207,521

(22) Filed: May 14, 2025

(51) Int. Cl. G05B 19/418; G16Y 40/60

(52) U.S. Cl. CPC G05B 19/41885; G05B 19/4185; G16Y 40/60

(57) ABSTRACT

IoT-driven incident simulation is provided. A set of IoT sensor data feeds needed to simulate an incident in a second industrial environment location is identified based on analyzing historic incident data associated with the incident occurring in a first industrial environment location. A simulation of the incident occurring in the second industrial environment location is generated to show impact of the incident on the second industrial environment location over a defined time duration utilizing the set of IoT sensor data feeds needed to simulate the incident in the second industrial environment location, environmental parameters of the first industrial environment location associated with the incident, and operational parameters of the first industrial environment location associated with the incident. The simulation of the incident occurring in the second industrial environment location is output to a client device user to view.

### BACKGROUND

The disclosure relates generally to industrial environments and more specifically to industrial environment simulations.

In any industrial activity environment (e.g., machine shop floor or the like), different types of incidents, such as, for example, fires, heavy machinery failures, electrical failures, chemical spills, steam leaks, pressure tank blasts, collisions, and the like, can occur. Each of these incidents can cause different types of damage in the industrial environment that may lead to costly downtimes and unexpected outcomes.

### SUMMARY

According to one illustrative embodiment, a method is provided. A computer, using a machine learning model, identifies a set of IoT sensor data feeds needed to simulate an incident in a second industrial environment location based on analyzing historic incident data associated with the incident occurring in a first industrial environment location. The computer, using a generative adversarial network, generates a simulation of the incident occurring in the second industrial environment location to show impact of the incident on the second industrial environment location over a defined time duration utilizing the set of IoT sensor data feeds needed to simulate the incident in the second industrial environment location, environmental parameters of the first industrial environment location associated with the incident, and operational parameters of the first industrial environment location associated with the incident. The computer, using the generative adversarial network, outputs the simulation of the incident occurring in the second industrial environment location to a client device user to view. According to other illustrative embodiments, a computer system and computer program product are provided.

### BRIEF DESCRIPTION OF THE DRAWINGS

FIG. 1 is a pictorial representation of a computing environment in which illustrative embodiments may be implemented;

FIGS. 2A-2B are a diagram illustrating an example of an IoT-driven incident simulation process in accordance with an illustrative embodiment; and

FIGS. 3A-3C are a flowchart illustrating a process for IoT-driven incident simulations in accordance with an illustrative embodiment.

### DETAILED DESCRIPTION

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A CPP embodiment is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

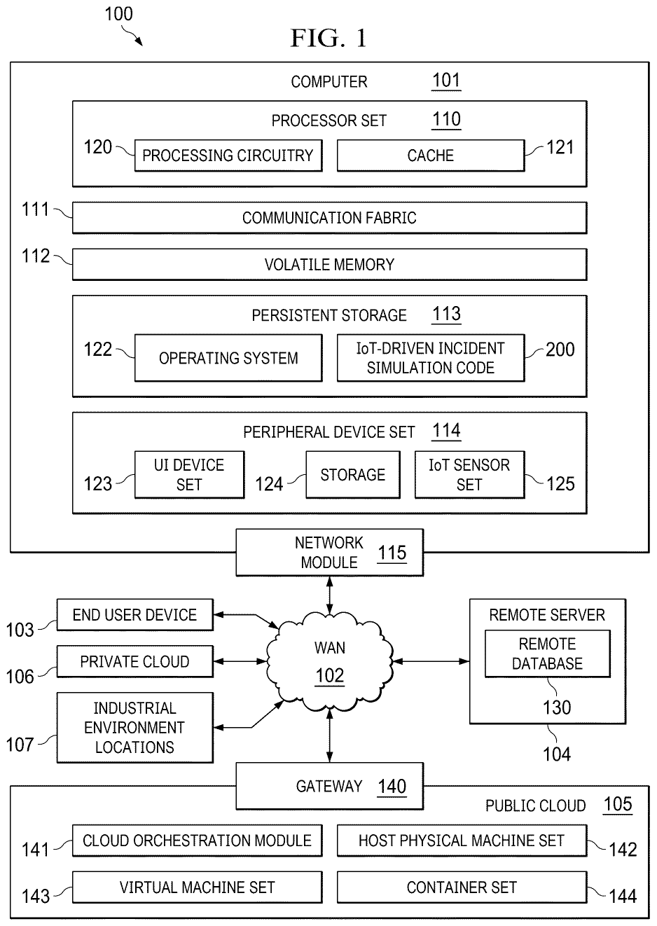

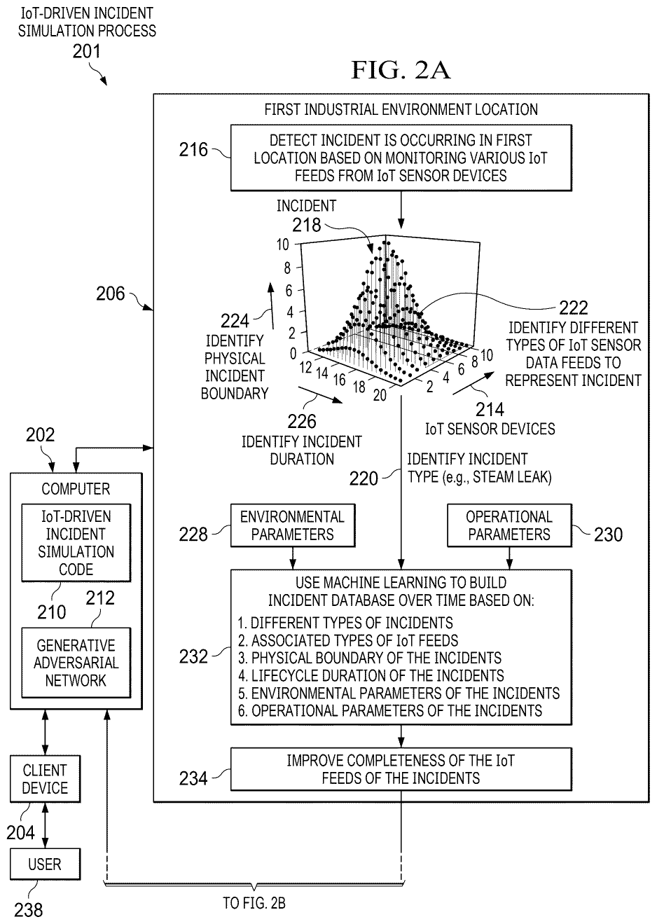

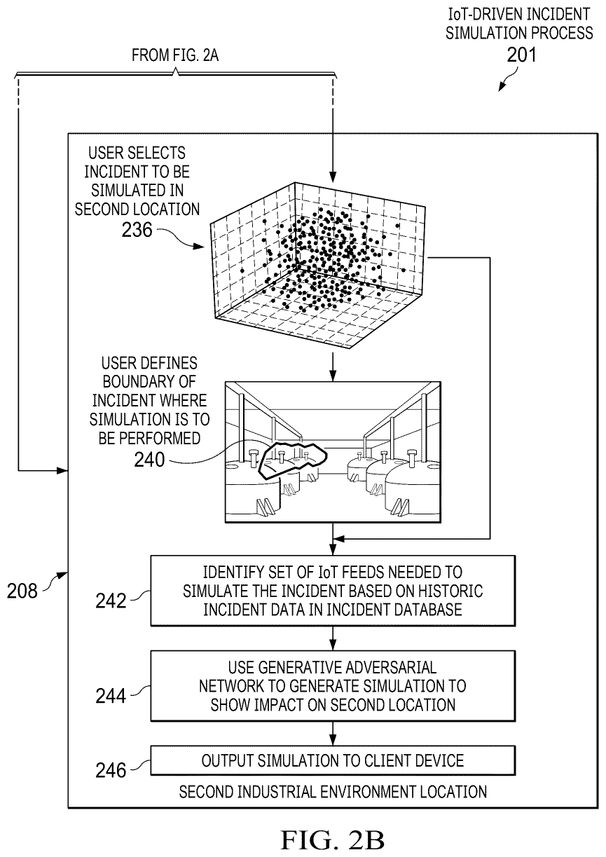

With reference now to the figures, and in particular, with reference to FIG. 1 and FIGS. 2A-2B, diagrams of data processing environments are provided in which illustrative embodiments may be implemented. It should be appreciated that FIG. 1 and FIGS. 2A-2B are only meant as examples and are not intended to assert or imply any limitation with regard to the environments in which different embodiments may be implemented. Many modifications to the depicted environments may be made.

FIG. 1 shows a pictorial representation of a computing environment in which illustrative embodiments may be implemented. Computing environment 100 contains an example of an environment for the execution of at least some of the computer code involved in performing the inventive methods of illustrative embodiments, such as IoT-driven incident simulation code 200.

For example, IoT-driven incident simulation code 200 monitors and records any incident in a first industrial environment location using a set of Internet of Things (IoT) sensor data feeds received from a set of IoT sensor devices located within the first industrial environment location for the duration of the incident. For example, IoT-driven incident simulation code 200 may detect that a steam leak is occurring in the first industrial environment location. As a result, IoT-driven incident simulation code 200 may collect and record a set of different types of IoT sensor data feeds corresponding to the steam leak from different types of IoT sensor devices located in the area of the steam leak. For example, an IoT temperature sensor device can measure temperature changes in the environment where the steam leak is occurring. An IoT pressure sensor device can measure pressure variations in steam pipes and surrounding areas, which can indicate loss of steam pressure due to the leak. An IoT humidity sensor device can measure increases in humidity levels in the area due to the steam leak. An IoT vibration sensor device can measure vibrations caused by the steam leak, which can affect nearby machinery and structures. An IoT flow sensor device can measure actual steam flow rates to identify discrepancies from expected steam flow rates. An IoT sound sensor device can detect hissing or other noise patterns associated with the steam leak. An IoT imaging sensor device (e.g., camera) can capture at least one of still images and videos of the steam leak to identify impact or effects of the steam on machinery, equipment, structures, surfaces, and the like in the area of the steam leak.

IoT-driven incident simulation code 200 can simulate different types of incidents that can happen in any industrial environment using IoT sensor data feeds received from different types of IoT sensor devices so that a user can visualize what can potentially happen to industrial activity when the same or similar incident occurs in a second industrial environment location. Thus, IoT-driven incident simulation code 200 can simulate impact of a user-selected incident, which IoT-driven incident simulation code 200 represents as a set of generated IoT sensor data feeds for a user-specified duration of time, in the second industrial environment location based on previously captured IoT sensor data feeds corresponding to the same or similar incident that occurred in the first industrial environment location.

For example, IoT-driven incident simulation code 200 captures a set of IoT sensor data feeds corresponding to a particular incident occurring in the first industrial environment location over a time period from various IoT sensor devices co-located in the first industrial environment location. The set of IoT sensor data feeds represent a complete lifecycle of the incident occurring at the first industrial environment location. IoT-driven incident simulation code 200 builds a database, library, or knowledgebase of incidents based on capturing a plurality of different sets of IoT sensor data feeds corresponding to a plurality of different incidents occurring in a plurality of different industrial environment locations over time.

IoT-driven incident simulation code 200 utilizes a generative adversarial network to generate a visual simulation of potential impact and changes that can occur in the second industrial environment location in response to the user selecting a specific incident to be simulated in the second industrial environment location. Using the generative adversarial network, IoT-driven incident simulation code 200 generates the visual simulation based on recorded IoT sensor data feeds corresponding to the same or similar incident that occurred in another industrial environment location, which IoT-driven incident simulation code 200 previously recorded in the incident database. IoT-driven incident simulation code 200 utilizes a set of machine learning models to improve the completeness of the IoT sensor data feeds corresponding to the different types of incidents recorded in the incident database to enable the generative adversarial network to generate accurate visual simulations showing the impact of different incidents on the second industrial environment location.

IoT-driven incident simulation code 200 allows the user to adjust at least one of intensity, magnitude, and duration of one or more incident attributes, such as, for example, incident produced force, temperature, vibration, and the like, while the user is viewing the simulation of the incident occurring in the second industrial environment location. IoT-driven incident simulation code 200 dynamically and automatically adapts or modifies the IoT sensor data feeds corresponding to the incident based on the number and type of incident attribute adjustments made by the user while watching the visual simulation of the incident in the second industrial environment location.

IoT-driven incident simulation code 200 utilizes the generative adversarial network to generate a three-dimensional (3D) space with relative 3D positioning of the incident in the second industrial environment location within the visual simulation. In addition, the generative adversarial network generates propagated sets of IoT sensor data feeds corresponding to the incident in this 3D space to demonstrate how incident attributes differ within a user-defined boundary of the incident in the second industrial environment location over time. For example, IoT sensor data feed values may be increased at the center or locus of the incident (e.g., higher air temperatures), whereas IoT sensor data feed values may be decreased at the edge or periphery of the user-defined boundary of the incident (e.g., lower air temperatures). Further, IoT sensor data feed values may be more intense at the beginning of the incident lifecycle (e.g., tremendous initial blast force), whereas IoT sensor data feed values may be less intense toward the end of the incident lifecycle (e.g., no blast force). IoT-driven incident simulation code 200 analyzes the visual simulation for changes within the user-defined boundary of the user-selected incident occurring in the second industrial environment location to identify which type of IoT sensor data feeds to generate during the simulation of the user-selected incident.

In addition to IoT-driven incident simulation code 200, computing environment 100 includes, for example, computer 101, wide area network (WAN) 102, end user device (EUD) 103, remote server 104, public cloud 105, private cloud 106, and industrial environment locations 107. In this embodiment, computer 101 includes processor set 110 (including processing circuitry 120 and cache 121), communication fabric 111, volatile memory 112, persistent storage 113 (including operating system 122 and IoT-driven incident simulation code 200, as identified above), peripheral device set 114 (including user interface (UI) device set 123, storage 124, and IoT sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a mainframe computer, quantum computer, desktop computer, laptop computer, tablet computer, or any other form of computer now known or to be developed in the future that is capable of, for example, running a program, accessing a network, and querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods of illustrative embodiments may be stored in IoT-driven incident simulation code 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports, and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open-source portable operating system interface-type operating systems that employ a kernel.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks, and even connections made through wide area networks such as the internet. In various embodiments, UI device set 123 may include components such as a display screen, speaker, microphone, wearable devices (such as smart glasses and smart watches), keyboard, mouse, printer, touchpad, and haptic devices.

Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (e.g., where computer 101 locally stores and manages a large database) then this storage may be provided by peripheral storage devices designed for storing very large amounts of data, such as a storage area network (SAN) that is shared by multiple, geographically distributed computers.

IoT sensor set 125 is made up of sensors that can be used in Internet of Things applications. For example, one sensor may be a thermometer, and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (e.g., embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (e.g., the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

EUD 103 is any computer system that is used and controlled by an end user (e.g., an industrial environment operator of an entity that utilizes the IoT-driven incident simulation services provided by computer 101), and may take any of the forms discussed above in connection with computer 101. EUD 103 typically receives helpful and useful data from the operations of computer 101. For example, in a hypothetical case where computer 101 is designed to provide a visual simulation of an incident occurring in one of industrial environment locations 107 to the end user, this visual simulation of the incident would typically be communicated from network module 115 of computer 101 through WAN 102 to EUD 103. In this way, EUD 103 can display, or otherwise present, the visual simulation of the incident to the end user. In some embodiments, EUD 103 may be a client device, such as a thin client, heavy client, mainframe computer, desktop computer, laptop computer, tablet computer, smart phone, and so on. Industrial environment locations 107 represent a plurality of different industrial environments such as machine shops, production lines, steel mills, warehouses, shipping sites, and the like. The end user can select which one of industrial environment locations 107 the end user wishes to see a simulation of the impact of a user-selected incident on that particular industrial environment location.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a visual simulation of an incident occurring in one of industrial environment locations 107 based on historical incident data, then this historical incident data may be provided to computer 101 from remote database 130 of remote server 104. Remote database 130 may be, for example, an incident database that records a plurality of different types of incidents occurring in one or more of industrial environment locations 107.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single entity. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Public cloud 105 and private cloud 106 are programmed and configured to deliver cloud computing services and/or microservices (not separately shown in FIG. 1). Unless otherwise indicated, the word “microservices” shall be interpreted as inclusive of larger “services” regardless of size. Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

As used herein, when used with reference to items, “a set of” means one or more of the items. For example, a set of clouds is one or more different types of cloud environments. Similarly, “a number of,” when used with reference to items, means one or more of the items. Moreover, “a group of” or “a plurality of” when used with reference to items, means two or more of the items.

Further, the term “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item B. This example may also include item A, item B, and item C or item B and item C. Of course, any combinations of these items may be present. In some illustrative examples, “at least one of” may be, for example, without limitation, two of item A, one of item B, and ten of item C, or four of item B and seven of item C, or other suitable combinations.

Illustrative embodiments monitor and record a set of IoT sensor data feeds received from various co-located IoT sensor devices in a given industrial environment location over a period of time, which represents the complete lifecycle of the incident at the given industrial environment location, to continually build an incident database. Afterward, illustrative embodiments use a generative adversarial network to simulate potential impact of the incident occurring in another industrial environment location. Illustrative embodiments utilize a set of IoT sensor data feeds corresponding to that same incident, which illustrative embodiments recorded in the incident database, to generate a visual simulation of the potential impact of that same incident within the other industrial environment location under same or similar circumstances (e.g., having same environmental and operational paraments within the user-defined boundary of that same incident occurring within the other industrial environment location).

For example, illustrative embodiments take into account different types of incidents, along with the corresponding set of IoT sensor data feeds throughout the lifecycle of each respective incident. In addition, illustrative embodiments use machine learning to improve the completeness of the various sets of IoT sensor data feeds corresponding to the different types of incidents, enabling illustrative embodiments to generate an accurate visual simulation of each different type of incident impact on a second industrial environment location.

While simulating the impact of a user-selected incident on the second industrial environment location, illustrative embodiments provide the user with an option to adjust at least one of an intensity, magnitude, and duration of various incident attributes (e.g., incident force, temperature, vibration, and the like). Illustrative embodiments use machine learning to modify the corresponding set of IoT sensor data feeds based on the user adjustments to the intensity, magnitude, or duration of one or more attributes of the incident. Illustrative embodiments use the generative adversarial network to generate a visual simulation of incident in the second industrial environment location based on the modified set of IoT sensor data feeds corresponding to the user adjustments to the intensity, magnitude, or duration of one or more attributes of the incident.

During simulation of the incident at the second industrial environment location, the user can define 3D positioning of the incident (e.g., a user-defined incident boundary) at that second industrial environment location. Using machine learning, illustrative embodiments generate a set of propagated IoT sensor data feeds corresponding to the incident within the 3D space. Based on the set of propagated IoT sensor data feeds, illustrative embodiments use the generative adversarial network to generate the visual simulation of the potential impact of the incident on the second industrial environment location.

While simulating any incident in the second industrial environment location, illustrative embodiments may take into account the context of that location by analyzing relevant environmental parameters and operational parameters captured by the set of IoT sensor data feeds. Using machine learning, illustrative embodiments modify the set of IoT sensor data feeds corresponding to the user-selected incident to match the context (e.g., the environmental and operational parameters) of the area in the first industrial environment location where the incident previously occurred. Then, illustrative embodiments use the generative adversarial network to generate an appropriate visual simulation of the user-selected incident occurring in the second industrial environment location. While generating the visual simulation of the user-selected incident in the second industrial environment location, illustrative embodiments analyze changes within the user-defined boundary of the incident based on historic incident data retrieved from the incident database to identify the types of IoT sensor data feeds to generate during the visual simulation of the incident in the second industrial environment location for accurate representation of the incident.

As a result, illustrative embodiments can provide entities, such as enterprises, companies, businesses, or the like, with proactive incident management and asset risk assessment based on analyzing IoT sensor data feeds of visual simulations corresponding to various incidents. By capturing and simulating IoT sensor data feeds associated with any type of incident, illustrative embodiments can generate visual simulations of potential impacts of incidents on assets, which will improve entity decision-making and operational efficiency. Thus, illustrative embodiments can revolutionize industrial risk management and operational preparedness of entities.

For example, illustrative embodiments can enable entities to anticipate and prepare for potential incidents occurring in advance. By simulating a wide range of incidents, such as fires, equipment failures, chemical leaks, and the like, across different industrial environment locations over the entire lifecycles of the incidents, illustrative embodiments can provide actionable insights, allowing entities to take preventive measures, and thereby potentially reduce downtime and minimize costly disruptions.

Further, viewing simulations of incidents allows operators to experience realistic outcomes and consequences of these incidents. Entities can use these visual simulations to enhance operator training and equip operators with knowledge on how to respond quickly and effectively when a real incident occurs, thereby reducing response time and mitigating damage.

Furthermore, by reducing the likelihood and impact of industrial incidents through visual simulations, entities can increase operational efficiency and cost savings by avoiding expensive repairs, legal liabilities, extended downtimes, and the like. Additionally, energy consumption and resource allocation during incident recovery can be optimized through predictive analysis.

Thus, illustrative embodiments provide one or more technical solutions that overcome a technical problem with accurately simulating incidents in other industrial environment locations. As a result, these one or more technical solutions provide a technical effect and practical application in the field of incident simulation.

With reference now to FIGS. 2A-2B, a diagram illustrating an example of an IoT-driven incident simulation process is depicted in accordance with an illustrative embodiment. IoT-driven incident simulation process 201 may be implemented in a computing environment, such as computing environment 100 in FIG. 1. IoT-driven incident simulation process 201 is a collection of hardware and software components for generating a visual simulation of an incident occurring in a second industrial environment location to show impact of the incident on the second industrial environment location based on a set of IoT sensor data feeds corresponding to the incident previously captured by IoT sensor devices located in a first industrial environment location.

In this example, IoT-driven incident simulation process 201 includes computer 202, client device 204, first industrial environment location 206, and second industrial environment location 208. Computer 202 may be, for example, computer 101 in FIG. 1. Client device 204 may be, for example, EUD 103 in FIG. 1. First industrial environment location 206 and second industrial environment location 208 may be, for example, industrial environment locations 107 in FIG. 1. However, it should be noted that IoT-driven incident simulation process 201 is intended as an example only and not as a limitation on illustrative embodiments. For example, IoT-driven incident simulation process 201 may include any number of computers, client devices, industrial environment locations, and other devices and components not shown.

Computer 202 includes IoT-driven incident simulation code 210, such as IoT-driven incident simulation code 200 in FIG. 1, and generative adversarial network 212. Generative adversarial network 212 is a deep neural network that learns the distribution of its training data and generates new data that closely mimics or is indistinguishable from real data. First industrial environment location 206 includes IoT sensor devices 214. IoT sensor devices 214 represent a plurality of different types of IoT sensor devices, such as temperature sensors, humidity sensors, pressure sensors, vibration sensors, velocity sensors, imaging sensors, sound sensors, and the like, located throughout first industrial environment location 206. IoT sensor devices 214 are capable of capturing and transmitting real time streams of sensor data to computer 202 for analysis.

IoT-driven incident simulation process 201 illustrates how illustrative embodiments capture and simulate incidents across multiple industrial environment locations, such as first industrial environment location 206 and second industrial environment location 208. IoT-driven incident simulation process 201 records in a centralized incident database the flow of IoT sensor data feeds representing the lifecycles of various incidents received from co-located IoT sensor devices, and any potential incident impact that can occur in a second industrial environment location, such as second industrial environment location 208. IoT-driven incident simulation process 201 utilizes the information contained in the incident database to identify possible changes that can happen in the second industrial environment location caused by a user-selected incident. As a result, IoT-driven incident simulation process 201 enables users to take proactive corrective actions to prevent any incident from occurring, or to reduce the impact of any incident, based on visual incident simulations.

At 216, computer 202 detects that incident 218 is occurring in first industrial environment location 206 based on monitoring various IoT sensor data feeds received from IoT sensor devices 214. At 220, in response to detecting incident 218, computer 202 identifies the type of incident 218 (e.g., steam leak). In addition, at 222, computer 202 identifies a set of different types of IoT sensor data feeds needed to accurately represent incident 218. Further, at 224, computer 202 identifies the physical boundary of incident 218. Furthermore, at 226, computer 202 identifies the time duration of incident 218.

Computer 202 collects and records the set of IoT sensor data feeds needed to accurately represent incident 218 received from IoT sensor devices 214 ensuring comprehensive coverage of the lifecycle of incident 218 including environmental parameters 228 and operational parameters 230 in the area surrounding incident 218, which is occurring in first industrial environment location 206. For example, any type of incident can generate multiple types of IoT sensor data values. As a result, it is necessary to comprehensively capture all relevant IoT sensor data feeds from corresponding IoT sensor devices in the area of the incident over the duration of the lifecycle of incident 218. It should be noted that the IoT sensor data values can vary in the area impacted by incident 218 (e.g., the IoT sensor data values may be higher at the source of incident 218 and then gradually lessen moving further from the source of incident 218).

While capturing the set of IoT sensor data feeds corresponding to incident 218 occurring in first industrial environment location 206, computer 202 also takes into account environmental parameters 228 and operational parameters 230 of industrial activities occurring in the area surrounding incident 218. Consequently, computer 202 utilizes various types of IoT sensor devices located around the area of incident 218 to collect, monitor, integrate, store, and process real time IoT sensor data feeds or streams.

Computer 202 continuously analyzes the IoT sensor data feeds corresponding to incident 218 occurring in first industrial environment location 206 to determine which particular set of IoT sensor data feeds will accurately depict what is occurring with incident 218. For example, while capturing the IoT sensor data feeds corresponding to incident 218 for the entire lifecycle of incident 218, computer 202 identifies which particular set of IoT sensor data feeds are having an impact and then correlate those IoT sensor data feeds as having some degree of relationship with incident 218. In addition, while capturing incident 218, computer 202 also captures environmental parameters 228 (e.g., temperature, humidity, weather, and the like), as well as operational parameters 230 (e.g., machine health metrics that include machine speed, vibration, heat, power usage, and the like).

At 232, computer 202 uses machine learning to build the incident database over time based on, for example, different types of incidents, associated types of IoT sensor data feeds, physical boundaries of the incidents, lifecycle duration of the incidents, environmental parameters of the incidents, operational parameters of the incidents, and the like. At 234, computer 202 uses machine learning to improve completeness of the IoT sensor data feeds of the incidents.

At 236, user 238 selects incident 218 to be simulated in second industrial environment location 208. However, it should be noted that user 238 can select any type of incident recorded in the incident database to be simulated in second industrial environment location 208. In addition, at 240, user 238 defines a boundary of incident 218 where the simulation is to be performed in second industrial environment location 208. Further, user 238 can also define a time duration for incident 218 to occur in second industrial environment location 208.

At 242, computer 202 identifies the particular set of IoT sensor data feeds to simulate incident 218 in second industrial environment location 208 for the user-defined period of time, starting from the start of incident 218 to the end of incident 218, to provide a full view of the lifecycle of incident 218 based on analyzing the historic incident data contained in the incident database. It should be noted that each of the set of IoT sensor data feeds can have a different intensity, magnitude, frequency of capture, and the like. Typically, the IoT sensor devices that capture the IoT sensor data feeds are placed in different locations of first industrial environment location 206, and based on criticality of a particular incident (e.g., fire, earthquake, or the like), computer 202 identifies which particular type of IoT sensor data feeds are needed for a visual simulation to accurately recreate that particular incident in second industrial environment location 208. For example, computer 202 can combine sensor data of different types of IoT sensor devices (e.g., combining temperature and humidity sensor data) in the same area to ensure multi-dimensional sensor data collection, improving incident resolution accuracy.

Using a set of user-defined rules for any incident, computer 202 can identify when any sensor data threshold value is reached and start capturing details regarding that particular incident occurring in first industrial environment location 206 to build the incident database. Computer 202 correlates IoT sensor data from multiple IoT sensor devices and combines the correlated IoT sensor data from the multiple IoT sensor devices for a holistic view of that particular incident (e.g., when machine vibration and temperature increase together, this may indicate machinery failure). Computer 202 utilizes machine learning to correlate that particular incident with different types of IoT sensor data feed values, along with the environmental and operational parameters in the area of that particular incident. Using a machine learning model trained on the historic incident data, computer 202 can identify whether any correction is needed in any of the IoT sensor data feed values corresponding to that particular incident, or whether any new types of IoT sensor data feeds need to be added, to ensure sensor data completeness to accurately represent that particular incident. Computer 202 can utilize, for example, a k-means clustering algorithm, neural network, or the like to detect anomalies in the incoming IoT sensor data feed values needing correction.

Computer 202 also collects environmental parameters 228 (e.g., weather conditions, humidity, temperature, and the like) and operational parameters 230 (e.g., machine speed, vibration, noise, and the like) while capturing the set of IoT sensor data feeds for the entire lifecycle of incident 218 occurring in first industrial environment location 206. Based on the identified set of IoT sensor data feeds needed to accurately depict incident 218, computer 202 continues to build the incident database. Computer 202 captures the set of IoT sensor data feeds in the physical incident boundary and time duration, which represents the incident occurring in first industrial environment location 206. Further, computer 202 also captures any visual impact of incident 218 on first industrial environment location 206 and stores the visual impact in the incident database as well. Using the historic incident data corresponding to a plurality of different types of incidents occurring in different industrial environment locations recorded in the incident database, computer 202 trains the machine learning model to modify or adapt the IoT sensor data feeds to improve the completeness of the historic incident data corresponding to the plurality of different types of incidents, which includes correcting incorrect values, adding missing values, and the like, to accurately represent each of the different types of incidents.

At 244, computer 202 utilizes generative adversarial network 212 to visually simulate realistic impact and changes in second industrial environment location 208 caused by user-selected incident 218 based on previously captured historic incident data recorded in the incident database. For example, once incident data is recorded in the incident database, user 238 may want to simulate that same incident, or a similar type of incident, occurring in second industrial environment location 208 to see what type of impact that particular incident will have on second industrial environment location 208 based on the recorded historic incident data. Using generative adversarial network 212, computer 202 identifies how the values of the set of IoT sensor data feeds are distributed in second industrial environment location 208 and simulates the potential impact on second industrial environment location 208 based on the historic incident data retrieved from the incident database.

Computer 202 retrieves from the incident database the set of relevant IoT sensor data feeds corresponding to incident 218 that previously occurred in first industrial environment location 206, including contextual incident data such as a set of videos of the incident area, environmental parameters 228, operational parameters 230, machine damage reports, and the like. Generative adversarial network 212 consisting of two networks, a generator network that generates IoT sensor data feeds corresponding to incident 218 and a discriminator network that tests whether the generated IoT sensor data feeds are realistic or not. Computer 202 uses generative adversarial network 212 to generate the potential impact of incident 218 on second industrial environment location 208 based on the historic incident data retrieved from the incident database, which is basically the set of IoT sensor data feeds needed to simulate incident 218 within second industrial environment location 208. Generative adversarial network 212 generates images of how second industrial environment location 208 may be affected under similar conditions that occurred in first industrial environment location 206.

Furthermore, generative adversarial network 212 can utilize a random noise vector (e.g., dummy IoT sensor data) to generate different possible variations of potential incident impact on second industrial environment location 208, allowing for diverse visual simulations of potential incident impact (e.g., varying the degree or level of damage caused by the incident) in the 3D space of the simulation. While generating the visual simulation of incident 218 within second industrial environment location 208 using generative adversarial network 212, computer 202 may also incorporate the same environmental parameters 228 and operational parameters 230 associated with first industrial environment location 206 into the simulation. It should be noted that computer 202 can generate a 3D space-based simulation and a time-based simulation. The time-based simulation shows how the impact of incident 218 on second industrial environment location 208 changes over time.

At 246, computer 202, using generative adversarial network 212, outputs the visual simulation of the impact of incident 218 on second industrial environment location 208 to client device 204 for user 238 to view. IoT-driven incident simulation process 201 enables user 238 to perform adjustments on the visual simulation of incident 218 to refine the visual simulation based on user 238 varying attributes or characteristics of the incident (e.g., varying intensity and duration of incident 218 as well as 3D positioning of incident 218 within the 3D space representing second industrial environment location 208). For example, while viewing the simulation of incident 218 in second industrial environment location 208, user 238 may make different types of adjustments to, for example, the IoT sensor data feed values to refine the simulation. Based on the adjustments to the simulation made by user 238, generative adversarial network 212 visually modifies incident 218 in the simulation. User 238 can utilize, for example, an augmented reality device or the like to make the adjustments to incident 218, such as adjust the user-defined 3D incident boundary, time range, or IoT sensor data values.

Generative adversarial network 212 receives the user adjustments to incident 218, and based on the user adjustments, generative adversarial network 212 generates changes in the visual simulation of incident 218 in second industrial environment location 208. For example, based on the user adjustments to the intensity and duration of incident 218, generative adversarial network 212 identifies how severe the impact of incident 218 will be on second industrial environment location 208 and modifies the visual simulation of the impact of incident 218 on second industrial environment location 208 accordingly. Moreover, based on the user-defined boundary of incident 218 in second industrial environment location 208, generative adversarial network 212 recalculates the spread of the IoT sensor data feed values corresponding to incident 218 across the user-defined incident boundary. Afterward, generative adversarial network 212 shows the spread of the IoT sensor data feed values corresponding to incident 218 across the user-defined incident boundary in the 3D visual simulation of incident 218 in second industrial environment location 208. Further, generative adversarial network 212 generates sequential frames showing how incident 218 evolves over the user-defined time period. Computer 202 can use, for example, a recurrent generative adversarial network to generate the time-based simulations to display how incident 218 spreads in second industrial environment location 208 over time.

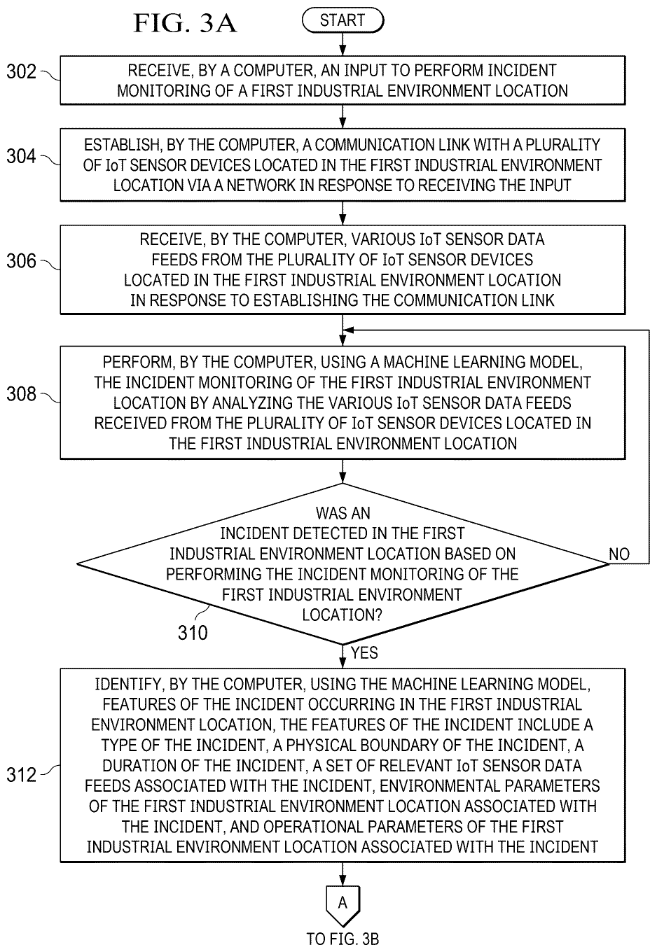

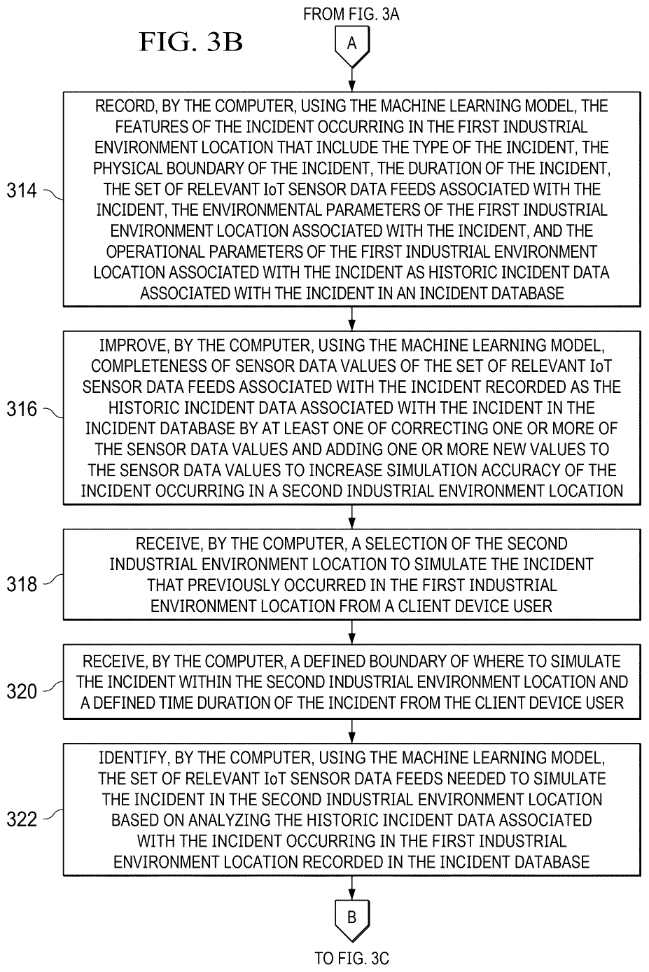

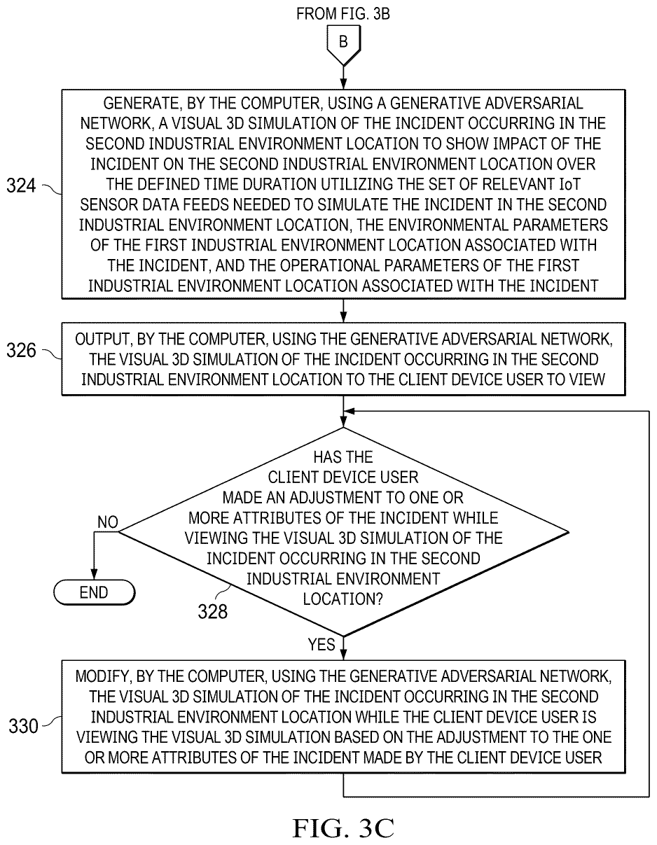

With reference now to FIGS. 3A-3C, a flowchart illustrating a process for IoT-driven incident simulations is shown in accordance with an illustrative embodiment. The process shown in FIGS. 3A-3C may be implemented in a computer, such as, for example, computer 101 in FIG. 1 or computer 202 in FIG. 2A. For example, the process shown in FIGS. 3A-3C may be implemented by IoT-driven incident simulation code 200 in FIG. 1 or IoT-driven incident simulation code 210 in FIG. 2A.

The process begins when the computer receives an input to perform incident monitoring of a first industrial environment location (step 302). The computer establishes a communication link with a plurality of IoT sensor devices located in the first industrial environment location via a network in response to receiving the input to perform the incident monitoring of the first industrial environment location (step 304).

The computer receives various IoT sensor data feeds from the plurality of IoT sensor devices located in the first industrial environment location in response to establishing the communication link (step 306). The computer, using a machine learning model, performs the incident monitoring of the first industrial environment location by analyzing the various IoT sensor data feeds received from the plurality of IoT sensor devices located in the first industrial environment location (step 308).

The computer, using the machine learning model, makes a determination as to whether an incident was detected in the first industrial environment location based on performing the incident monitoring of the first industrial environment location (step 310). If the computer, using the machine learning model, determines that no incident was detected in the first industrial environment location based on performing the incident monitoring of the first industrial environment location, no output of step 310, then the process returns to step 308 where the computer continues to perform the incident monitoring of the first industrial environment location. If the computer, using the machine learning model, determines that an incident was detected in the first industrial environment location based on performing the incident monitoring of the first industrial environment location, yes output of step 310, then the computer, using the machine learning model, identifies features of the incident occurring in the first industrial environment location (step 312). The features of the incident include a type of the incident, a physical boundary of the incident, a duration of the incident, a set of relevant IoT sensor data feeds associated with the incident, environmental parameters of the first industrial environment location associated with the incident, and operational parameters of the first industrial environment location associated with the incident.

The computer, using the machine learning model, records the features of the incident occurring in the first industrial environment location that include the type of the incident, the physical boundary of the incident, the duration of the incident, the set of relevant IoT sensor data feeds associated with the incident, the environmental parameters of the first industrial environment location associated with the incident, and the operational parameters of the first industrial environment location associated with the incident as historic incident data associated with the incident in an incident database (step 314). The computer, using the machine learning model, improves completeness of sensor data values of the set of relevant IoT sensor data feeds associated with the incident recorded as the historic incident data associated with the incident in the incident database by at least one of correcting one or more of the sensor data values and adding one or more new values to the sensor data values to increase simulation accuracy of the incident occurring in a second industrial environment location (step 316).

Subsequently, the computer receives a selection of the second industrial environment location to simulate the incident that previously occurred in the first industrial environment location from a client device user (step 318). In addition, the computer receives a defined boundary of where to simulate the incident within the second industrial environment location and a defined time duration of the incident from the client device user (step 320). Further, the computer, using the machine learning model, identifies the set of relevant IoT sensor data feeds needed to simulate the incident in the second industrial environment location based on analyzing the historic incident data associated with the incident occurring in the first industrial environment location recorded in the incident database (step 322).

The computer, using a generative adversarial network, generates a visual 3D simulation of the incident occurring in the second industrial environment location to show impact of the incident on the second industrial environment location over the defined time duration utilizing the set of relevant IoT sensor data feeds needed to simulate the incident in the second industrial environment location, the environmental parameters of the first industrial environment location associated with the incident, and the operational parameters of the first industrial environment location associated with the incident (step 324). The computer, using the generative adversarial network, outputs the visual 3D simulation of the incident occurring in the second industrial environment location to the client device user to view (step 326).

The computer, using the generative adversarial network, makes a determination as to whether the client device user made an adjustment to one or more attributes of the incident while viewing the visual 3D simulation of the incident occurring in the second industrial environment location (step 328). If the computer, using the generative adversarial network, determines that the client device user has made an adjustment to one or more attributes of the incident while viewing the visual 3D simulation of the incident occurring in the second industrial environment location, yes output of step 328, then the computer, using the generative adversarial network, modifies the visual 3D simulation of the incident occurring in the second industrial environment location while the client device user is viewing the visual 3D simulation based on the adjustment to the one or more attributes of the incident made by the client device user (step 330). Thereafter, the process returns to step 328 where the computer determines whether the client device user has made another adjustment to attributes of the incident. If the computer, using the generative adversarial network, determines that the client device user has not made an adjustment to one or more attributes of the incident while viewing the visual 3D simulation of the incident occurring in the second industrial environment location, no output of step 328, then the process terminates thereafter.

Thus, illustrative embodiments of the present disclosure provide a computer-implemented method, computer system, and computer program product for generating a visual simulation of an incident occurring in a second industrial environment location to show impact of the incident on the second industrial environment location based on a set of IoT sensor data feeds corresponding to the incident previously captured by IoT sensor devices located in a first industrial environment location. The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
identifying, by a computer, using a machine learning model, a set of IoT sensor data feeds needed to simulate an incident in a second industrial environment location based on analyzing historic incident data associated with the incident occurring in a first industrial environment location;
generating, by the computer, using a generative adversarial network, a simulation of the incident occurring in the second industrial environment location to show impact of the incident on the second industrial environment location over a defined time duration utilizing the set of IoT sensor data feeds needed to simulate the incident in the second industrial environment location, environmental parameters of the first industrial environment location associated with the incident, and operational parameters of the first industrial environment location associated with the incident; and
outputting, by the computer, using the generative adversarial network, the simulation of the incident occurring in the second industrial environment location to a client device user to view.

2. The method of claim 1, further comprising:
determining, by the computer, using the generative adversarial network, whether the client device user made an adjustment to one or more attributes of the incident while viewing the simulation of the incident occurring in the second industrial environment location; and
responsive to the computer determining, using the generative adversarial network, that the client device user has made the adjustment to the one or more attributes of the incident while viewing the simulation of the incident occurring in the second industrial environment location, modifying, the computer, using the generative adversarial network, the simulation of the incident occurring in the second industrial environment location while the client device user is viewing the simulation based on the adjustment to the one or more attributes of the incident made by the client device user.

3. The method of claim 1, further comprising:
receiving, by the computer, a selection of the second industrial environment location to simulate the incident that previously occurred in the first industrial environment location from the client device user; and
receiving, by the computer, a defined boundary of where to simulate the incident within the second industrial environment location and the defined time duration of the incident from the client device user.

4. The method of claim 1, further comprising:
receiving, by the computer, an input to perform incident monitoring of the first industrial environment location;
establishing, by the computer, a communication link with a plurality of IoT sensor devices located in the first industrial environment location via a network in response to receiving the input to perform the incident monitoring of the first industrial environment location; and
receiving, by the computer, various IoT sensor data feeds from the plurality of IoT sensor devices located in the first industrial environment location in response to establishing the communication link.

5. The method of claim 4, further comprising:
performing, by the computer, using the machine learning model, the incident monitoring of the first industrial environment location by analyzing the various IoT sensor data feeds received from the plurality of IoT sensor devices located in the first industrial environment location;
determining, by the computer, using the machine learning model, whether the incident was detected in the first industrial environment location based on performing the incident monitoring of the first industrial environment location; and
responsive to the computer determining, using the machine learning model, that the incident was detected in the first industrial environment location based on performing the incident monitoring of the first industrial environment location, identifying, by the computer, using the machine learning model, features of the incident occurring in the first industrial environment location, the features of the incident include a type of the incident, a physical boundary of the incident, a duration of the incident, the set of IoT sensor data feeds associated with the incident, the environmental parameters of the first industrial environment location associated with the incident, and the operational parameters of the first industrial environment location associated with the incident.

6. The method of claim 5, further comprising:
recording, by the computer, using the machine learning model, the features of the incident occurring in the first industrial environment location that include the type of the incident, the physical boundary of the incident, the duration of the incident, the set of IoT sensor data feeds associated with the incident, the environmental parameters of the first industrial environment location associated with the incident, and the operational parameters of the first industrial environment location associated with the incident as the historic incident data associated with the incident in an incident database.

7. The method of claim 6, further comprising:
improving, by the computer, using the machine learning model, completeness of sensor data values of the set of IoT sensor data feeds associated with the incident recorded as the historic incident data in the incident database by at least one of correcting one or more of the sensor data values and adding one or more new values to the sensor data values to increase simulation accuracy of the incident occurring in the second industrial environment location.

8. A computer system comprising:
a processor set;
one or more computer-readable storage media; and
program instructions stored on the one or more computer-readable storage media to cause the processor set to perform operations comprising:
identifying, using a machine learning model, a set of IoT sensor data feeds needed to simulate an incident in a second industrial environment location based on analyzing historic incident data associated with the incident occurring in a first industrial environment location;
generating, using a generative adversarial network, a simulation of the incident occurring in the second industrial environment location to show impact of the incident on the second industrial environment location over a defined time duration utilizing the set of IoT sensor data feeds needed to simulate the incident in the second industrial environment location, environmental parameters of the first industrial environment location associated with the incident, and operational parameters of the first industrial environment location associated with the incident; and
outputting, using the generative adversarial network, the simulation of the incident occurring in the second industrial environment location to a client device user to view.

9. The computer system of claim 8, wherein the operations further comprise:
determining, using the generative adversarial network, whether the client device user made an adjustment to one or more attributes of the incident while viewing the simulation of the incident occurring in the second industrial environment location; and
responsive to determining, using the generative adversarial network, that the client device user has made the adjustment to the one or more attributes of the incident while viewing the simulation of the incident occurring in the second industrial environment location, modifying, using the generative adversarial network, the simulation of the incident occurring in the second industrial environment location while the client device user is viewing the simulation based on the adjustment to the one or more attributes of the incident made by the client device user.

10. The computer system of claim 8, wherein the operations further comprise:
receiving a selection of the second industrial environment location to simulate the incident that previously occurred in the first industrial environment location from the client device user; and
receiving a defined boundary of where to simulate the incident within the second industrial environment location and the defined time duration of the incident from the client device user.

11. The computer system of claim 8, wherein the operations further comprise:
receiving an input to perform incident monitoring of the first industrial environment location;
establishing a communication link with a plurality of IoT sensor devices located in the first industrial environment location via a network in response to receiving the input to perform the incident monitoring of the first industrial environment location; and
receiving various IoT sensor data feeds from the plurality of IoT sensor devices located in the first industrial environment location in response to establishing the communication link.

12. The computer system of claim 11, wherein the operations further comprise:
performing, using the machine learning model, the incident monitoring of the first industrial environment location by analyzing the various IoT sensor data feeds received from the plurality of IoT sensor devices located in the first industrial environment location;
determining, using the machine learning model, whether the incident was detected in the first industrial environment location based on performing the incident monitoring of the first industrial environment location; and
responsive to determining, using the machine learning model, that the incident was detected in the first industrial environment location based on performing the incident monitoring of the first industrial environment location, identifying, using the machine learning model, features of the incident occurring in the first industrial environment location, the features of the incident include a type of the incident, a physical boundary of the incident, a duration of the incident, the set of IoT sensor data feeds associated with the incident, the environmental parameters of the first industrial environment location associated with the incident, and the operational parameters of the first industrial environment location associated with the incident.

13. The computer system of claim 12, wherein the operations further comprise:
recording, using the machine learning model, the features of the incident occurring in the first industrial environment location that include the type of the incident, the physical boundary of the incident, the duration of the incident, the set of IoT sensor data feeds associated with the incident, the environmental parameters of the first industrial environment location associated with the incident, and the operational parameters of the first industrial environment location associated with the incident as the historic incident data associated with the incident in an incident database.

14. A computer program product comprising:
one or more computer-readable storage media; and
program instructions stored on the one or more computer-readable storage media to perform operations comprising:
identifying, by a computer, using a machine learning model, a set of IoT sensor data feeds needed to simulate an incident in a second industrial environment location based on analyzing historic incident data associated with the incident occurring in a first industrial environment location;
generating, by the computer, using a generative adversarial network, a simulation of the incident occurring in the second industrial environment location to show impact of the incident on the second industrial environment location over a defined time duration utilizing the set of IoT sensor data feeds needed to simulate the incident in the second industrial environment location, environmental parameters of the first industrial environment location associated with the incident, and operational parameters of the first industrial environment location associated with the incident; and
outputting, by the computer, using the generative adversarial network, the simulation of the incident occurring in the second industrial environment location to a client device user to view.

15. The computer program product of claim 14, wherein the operations further comprise:
determining, by the computer, using the generative adversarial network, whether the client device user made an adjustment to one or more attributes of the incident while viewing the simulation of the incident occurring in the second industrial environment location; and
responsive to the computer determining, using the generative adversarial network, that the client device user has made the adjustment to the one or more attributes of the incident while viewing the simulation of the incident occurring in the second industrial environment location, modifying, the computer, using the generative adversarial network, the simulation of the incident occurring in the second industrial environment location while the client device user is viewing the simulation based on the adjustment to the one or more attributes of the incident made by the client device user.

16. The computer program product of claim 14, wherein the operations further comprise:
receiving, by the computer, a selection of the second industrial environment location to simulate the incident that previously occurred in the first industrial environment location from the client device user; and
receiving, by the computer, a defined boundary of where to simulate the incident within the second industrial environment location and the defined time duration of the incident from the client device user.

17. The computer program product of claim 14, wherein the operations further comprise:
receiving, by the computer, an input to perform incident monitoring of the first industrial environment location;
establishing, by the computer, a communication link with a plurality of IoT sensor devices located in the first industrial environment location via a network in response to receiving the input to perform the incident monitoring of the first industrial environment location; and
receiving, by the computer, various IoT sensor data feeds from the plurality of IoT sensor devices located in the first industrial environment location in response to establishing the communication link.

18. The computer program product of claim 17, wherein the operations further comprise:
performing, by the computer, using the machine learning model, the incident monitoring of the first industrial environment location by analyzing the various IoT sensor data feeds received from the plurality of IoT sensor devices located in the first industrial environment location;
determining, by the computer, using the machine learning model, whether the incident was detected in the first industrial environment location based on performing the incident monitoring of the first industrial environment location; and
responsive to the computer determining, using the machine learning model, that the incident was detected in the first industrial environment location based on performing the incident monitoring of the first industrial environment location, identifying, by the computer, using the machine learning model, features of the incident occurring in the first industrial environment location, the features of the incident include a type of the incident, a physical boundary of the incident, a duration of the incident, the set of IoT sensor data feeds associated with the incident, the environmental parameters of the first industrial environment location associated with the incident, and the operational parameters of the first industrial environment location associated with the incident.

19. The computer program product of claim 18, wherein the operations further comprise:
recording, by the computer, using the machine learning model, the features of the incident occurring in the first industrial environment location that include the type of the incident, the physical boundary of the incident, the duration of the incident, the set of IoT sensor data feeds associated with the incident, the environmental parameters of the first industrial environment location associated with the incident, and the operational parameters of the first industrial environment location associated with the incident as the historic incident data associated with the incident in an incident database.

20. The computer program product of claim 19, wherein the operations further comprise:
improving, by the computer, using the machine learning model, completeness of sensor data values of the set of IoT sensor data feeds associated with the incident recorded as the historic incident data in the incident database by at least one of correcting one or more of the sensor data values and adding one or more new values to the sensor data values to increase simulation accuracy of the incident occurring in the second industrial environment location.
